(19) United States
(12) Patent Application Publication
(10) Pub. No.: US 2005/0114498 A1
(43) Pub. Date: May 26, 2005

(54) Method and apparatus for managing data transfer in a data processing system

(75) Inventors: Ron Encarnacion Gonzalez, Austin, TX (US); Binh K. Hua, Austin, TX (US); Sivarama K. Kodukula, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/702,995

(22) Filed: Nov. 6, 2003

(51) Int. Cl. G06F 15/173

(52) U.S. Cl. 709/224

(57) ABSTRACT

A method, apparatus, and computer instructions for managing data transfer in a data processing system. An amount of space available for storing data in a receive buffer is detected. In response to the amount of space available, a first priority for a receive function and a second priority for a transfer function is set. The first priority and the second priority is used to access resources for the data transfer.

### BACKGROUND OF THE INVENTION

1. Technical Field

The present invention relates generally to an improved data processing system and in particular to a method and apparatus for managing the transfer of data in a data processing system. Still more particularly, the present invention provides a method, apparatus, and computer instructions for managing the transfer of data in a receive buffer in a data processing system.

2. Description of Related Art

An Ethernet port may be found in devices, such as a switch, or in a network adapter. Transmit and receive buffers are used to store frame data handled by an Ethernet port. Under ideal conditions in a network data processing system, no contention occurs for these resources. Under actual conditions, however, received data may be lost due to overruns in the receive buffer. These conditions may result from heavy network traffic or excessive latencies within the network data processing system.

Data is lost when the data packets are received faster in the receive buffer in the port than they are transmitted or moved out of the receive buffer. The receive buffer fills in and the data may be lost. To avoid the loss of data, flow control is employed. One mechanism involved uses I.E.E.E.802.3x, which is a flow control standard that sends a “pause frame” with a pause timer value requesting the linked partner to not send any data frames within the timer value. In this manner, an Ethernet port may regulate the flow of data with its linked partner. To terminate the pause condition before the timer has expired, another pause frame may be sent with a pause timer value of zero to the linked partner.

When data in a receive buffer exceeds a predefined threshold, the port sends out a pause frame with a pause timer value greater than zero. This pause frame is also referred to as an “XOFF” pause frame. This type of frame is a “pause” request, instructing the linked partner to stop transmitting data for the length of time specified in the pause timer value. The linked partner stops sending data accordingly when receiving this frame.

If the buffer level is still above the threshold level at the end of the pause period, the Ethernet port sends out another XOFF pause frame to request another pause period. This process repeats until the data in a receive buffer falls below the predefined threshold level. At this time, the Ethernet port sends out a different type of pause frame with a pause timer value set equal to zero. This type of pause frame also is referred to as a “XON” pause frame. This type of frame is used to signal the completion of the pause process. The linked partner then resumes sending data after receiving this XON pause frame. The number of XOFF pause periods depends on the data transfer rate between the Ethernet port's receiving buffer and the system.

This flow control mechanism currently only works between two adjacent linked partners. These partners are, for example, a data processing system and its immediate switch port or another data processing system. This mechanism does not include a capacity to throttle the network traffic from the start point to the end point in which multiple nodes or devices may be present. As a result, when a receiving data processing system receives overruns and takes an excessive amount of time to clear the receive buffer, the potential is present to overrun the buffers in the linked partner switch port. This situation may eventually lead to overruns in other ports within the switch and propagate to other switches in the network. Therefore, when the Ethernet port is in an XOFF mode, the Ethernet port should shift back out of this state as soon as possible by receiving the data from the receive buffer quickly.

Therefore, it would be advantageous to have an improved method, apparatus, and computer instructions for managing the transfer of data in a buffer within a data processing system.

### SUMMARY OF THE INVENTION

The present invention provides a method, apparatus, and computer instructions for managing data transfer in a data processing system. An amount of space available for storing data in a receive buffer is detected. In response to the amount of space available, a first priority for a receive function and a second priority for a transfer function is set. The first priority and the second priority are used to access resources for the data transfer.

### BRIEF DESCRIPTION OF THE DRAWINGS

The novel features believed characteristic of the present invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram of a network adapter in accordance with a preferred embodiment of the present invention;

FIG. 4 is a diagram of components used in managing receive and transmit functions in an adapter in accordance with a preferred embodiment of the present invention;

FIG. 5 is a table illustrating priorities for different zones in a receive buffer in accordance with a preferred embodiment of the present invention; and

FIG. 6 is a flowchart of a process for managing transmit and receive functions in accordance with a preferred embodiment of the present invention.

### DETAILED DESCRIPTION OF THE PREFERRED EMBODIMENT

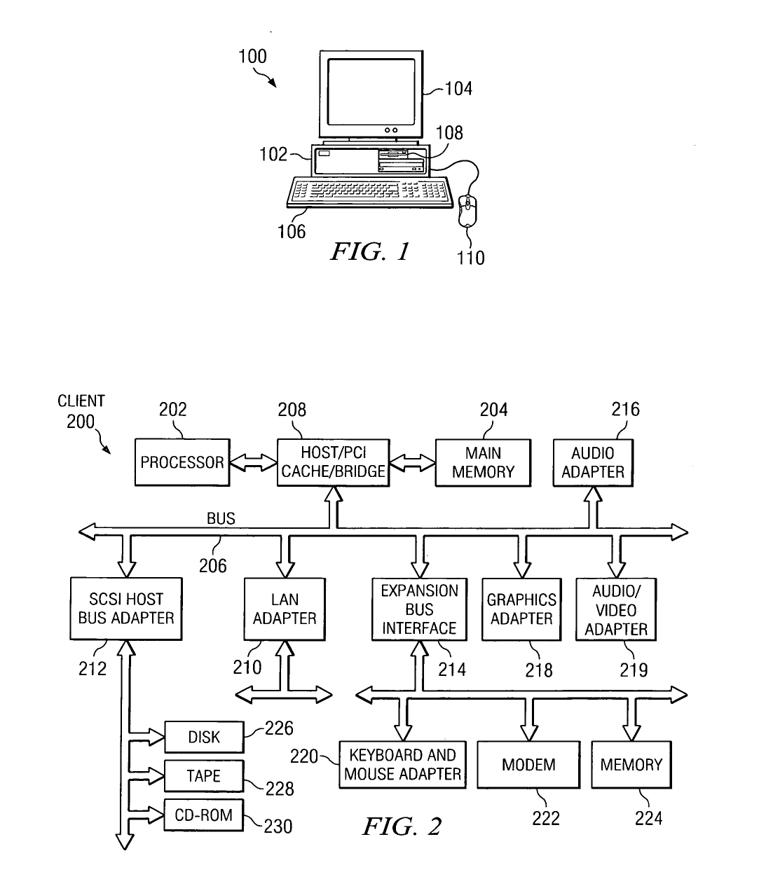

With reference now to the figures and in particular with reference to FIG. 1, a pictorial representation of a data processing system in which the present invention may be implemented, is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with computer 100, such as, for example, a joystick, touchpad, touch screen, trackball, microphone, and the like. Computer 100 can be implemented using any suitable computer, such as an IBM eserver computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as network adapter 210, modem 222, or the like.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a method, apparatus, and computer instructions for managing the transfer of data in a receive buffer. The mechanism of the present invention recognizes a number of factors are present in the emptying of data from a buffer. One factor is the transfer rate priority between the adapter and the system input/output (I/O) bus. This priority is initialized during the initial program load with a predetermined value in these illustrative examples. A factor recognized by the present invention is that during an XOFF mode, a mode in which the data transfer from the linked partner has been requested to pause, the transmitting side of the Ethernet port continues to transfer data to the network. The I/O bus in the data processing system, in which the adapter is located, continues to be shared between the transmitting side and the receiving side of the Ethernet port.

Further, the Ethernet port also may be transmitting “data request” and “acknowledge” frames. These frames, in turn, generate traffic for the receive side. As a result, the transmission of these types of requests may aggravate the overflow situation since the Ethernet port is already in a pause state. The mechanism of the present invention recognizes that the contention for system resources occurs when the transmitting side is active and not in an idle state or mode. The activity on the transmitting side results in a longer amount of time for the Ethernet port to transfer received data in the buffer to the data processing system from the port.

Thus, the mechanism of the present invention recognizes that the continuation of the transmission of data may inhibit the port from exiting or shifting out of the XOFF state as quickly as possible. The mechanism of the present invention minimizes the probability for an Ethernet port from entering an XOFF mode. This mechanism increases the receive priority based on the amount of data in the receive buffer.

Further, if a port enters the XOFF mode, the mechanism of the present invention forces the transmitting logic into an idle mode in these illustrative examples. By forcing the transmitting logic into an idle mode, the emptying of the receive data may be sped up, resulting in the XOFF mode lasting for a shorter period of time.

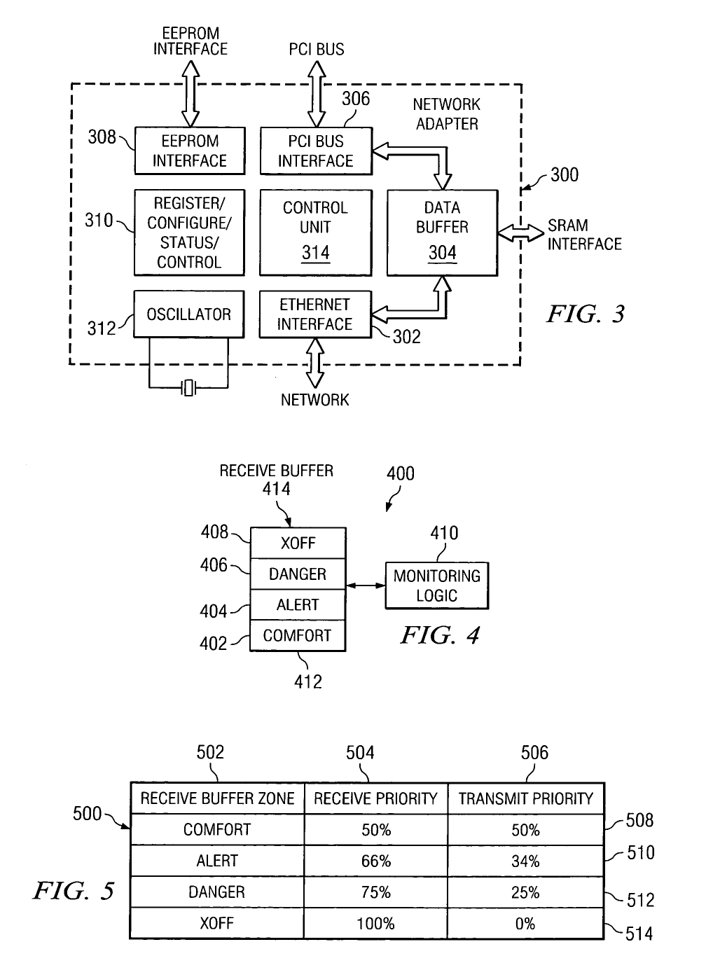

Turning now to FIG. 3, a diagram of a network adapter is depicted in accordance with a preferred embodiment of the present invention. Network adapter 300 may be implemented as LAN adapter 210 in FIG. 2. As shown, network adapter 300 includes Ethernet interface 302, data buffer 304, and PCI bus interface 306. These three components provide a path between the network and the bus of the data processing system. Ethernet interface 302 provides an interface to the network connected to the data processing system. PCI bus interface 306 provides an interface to a bus, such as PCI bus 206 in FIG. 2. Data buffer 304 is used to store data being transmitted and received through network adaptor 300. This data buffer also includes a connection to an SRAM interface to provide for additional storage.

Network adaptor 300 also includes electrically erasable programmable read-only memory (EEPROM) interface 308, register/configure/status/control unit 310, oscillator 312, and control unit 314. EEPROM interface 308 provides an interface to an EEPROM chip, which may contain instructions and other configuration information for network adaptor 300. Different parameters and setting may be stored on an EEPROM chip through EEPROM interface 308. Register/configure/status/control unit 310 provides a place to store information used to configure and run processes on network adaptor 300. For example, a timer value for a timer may be stored within these registers. Additionally, status information for different processes also may be stored within this unit. Oscillator 312 provides a clock signal for executing processes on network adaptor 300.

Control unit 314 controls the different processes and functions performed by network adaptor 300. Control unit 314 may take various forms. For example, control unit 314 may be a processor or an application-specific integrated chip (ASIC). In these examples, the processes of the present invention used to manage flow control of data are executed by control unit 314. If implemented as a processor, the instructions for these processes may be stored in a chip accessed through EEPROM interface 308.

Data is received in receive operations through Ethernet interface 302. This data is stored in data buffer 304 for transfer onto the data processing system across PCI bus interface 306. For example, the data may be transferred onto a bus, such as PCI local bus 206 in FIG. 2. If an overflow condition exists, new data may not be stored on data buffer 304 because the buffer is full. This type of situation may exist when network adaptor 300 is unable to send received data in data buffer 304 to the data processing system at a rate that is fast enough to reduce the data in data buffer 304 faster than data is placed into this data buffer.

This overflow condition is minimized through the use of a receive buffer monitoring logic or process implemented within control unit 314. This monitoring logic is employed to dynamically detect the amount of storage available within data buffer 304. Specifically, the amount of space available in the receive portion of data buffer 304 is monitored and the priority for transmit and receive operations is adjusted based on the amount of space that is available in the receive portion of data buffer 304. The receive buffer is divided into different zones and different priorities are assigned for the transmission and receive functions in network adapter 300. These different priorities may be tuned and customized for a given data processing system as necessary.

Further, this mechanism also may be implemented within a port for other types of devices, such as a switch, in addition to those used within a data processing system, such as data processing system 200 in FIG. 2. By adjusting the transmit and receive functions, latencies within the network data processing system may be compensated for to avoid overruns within the receive portion of data buffer 304. In addition, if an overflow condition occurs within the receive buffer portion of data buffer 304, control unit 314 may generate and transmit appropriate pause frames onto the network through Ethernet interface 302. These pause frames are designed to cause the source of the data, the linked partner, to halt transmission of data for some period of time set in the pause frame.

If the overflow condition continues, another pause frame may be transmitted prior to the expiration of this period of time. If the threshold level is no longer exceeded in data buffer 304, control unit 314 disables the flow control causing the transmission of pause frames to terminate. Further, if the period of time has not expired after sending the last pause frame, control unit 314 may transmit a pause frame with the period of time set equal to zero to cause the source to start transmitting data again prior to the expiration of the period of time. The use of this flow control in conjunction with the changing of priorities for receive and transmit functions reduces the amount of time that an overflow situation exists, in the event that one occurs.

With reference now to FIG. 4, a diagram of components used in managing receive and transmit functions in an adapter is depicted in accordance with a preferred embodiment of the present invention. As illustrated, receive buffer 400 is divided into four zones, comfort 402, alert 404, danger 406, and XOFF 408. Receive buffer 400 is a portion of a buffer, such as data buffer 304 in FIG. 3 that has been designated for receiving data. Monitoring logic 410 may be implemented as instructions or circuitry within control unit 314 in FIG. 3. Monitoring logic 410 is used to monitor the amount of space present in receive buffer 400. In the illustrated examples, data is filled starting from bottom end 412 towards top end 414. As the amount of data increases, different portions of receive buffer 400 are used or occupied.

An initial or default priority for transmit and receive functions are set when the system is initialized. These priorities do not change as long as the amount of data in receive buffer 400 only fills comfort zone 402. When the amount of data within receive buffer 400 reaches alert zone 404, the priorities for transmit and receive functions may be adjusted to increase the priority for receive functions. This priority is changed in response to the increasing amount of data within receive buffer 400. The priorities may again be changed if the amount of data in receive buffer 400 fills the buffer to reach danger zone 406.

Finally, if the data reaches XOFF zone 408, a threshold level has been reached to cause the transmission of a pause frame. In addition, in the illustrative examples, the transmit functions are then assigned a priority of zero, while the receive functions receive 100 percent priority with respect to the usage of resources to transmit data. In other words, the transmit functions are placed into an idle mode, while the receive functions continue to process data in the buffer.

With reference now to FIG. 5, a table illustrating priorities for different zones in a receive buffer is depicted in accordance with a preferred embodiment of the present invention. In this example table 500 includes four entries in three columns. Column 502 identifies the highest receive buffer zone that is being used. In these examples, the comfort zone is the lowest zone while the XOFF zone is the highest zone. Column 504 identifies the receive priority, while column 506 identifies the transmit priority. Entry 508 corresponds to the comfort zone in which the receive priority and the transmit priority are given equal values of 50 percent.

If the amount of data in the receive buffer reaches the alert zone, entry 510 indicates that the receive priority is given a value of 66 percent while the transmit priority is given a value of 34 percent. Entry 512 is for a danger zone in which the receive priority is given a value of 75 percent while the transmit priority is given a value of 25 percent. In entry 514, when data reaches the XOFF zone or threshold, the receive priority is given a value of 100 percent while the transmit priority is given a value of zero percent. As the percentage for the receive priority increases, the direct memory access (DMA) engine used to transfer data from the data buffer is more favorable to receiving data then transmitting data. The received data will be transferred across system I/O bus more quickly, as compared to transmit data. The receive side is placed in a fast mode and transmit side is placed in a slow mode. How fast the receive side can transfer data in these illustrative examples depends on the buffer zone and percent priority of each buffer zone.

The values illustrated in table 500 are presented merely for purposes of illustration. These values may be tuned or customized for a given system as necessary. Additionally, other numbers of zones may be used other than those illustrated, depending on the particular implementation. This type of dynamic I/O bandwidth helps minimize or eliminate overruns in the receive buffer by continually adjusting the receive and transmit priorities to compensate for latencies in the network data processing system. This type of mechanism also minimizes the bottlenecks in the overall network.

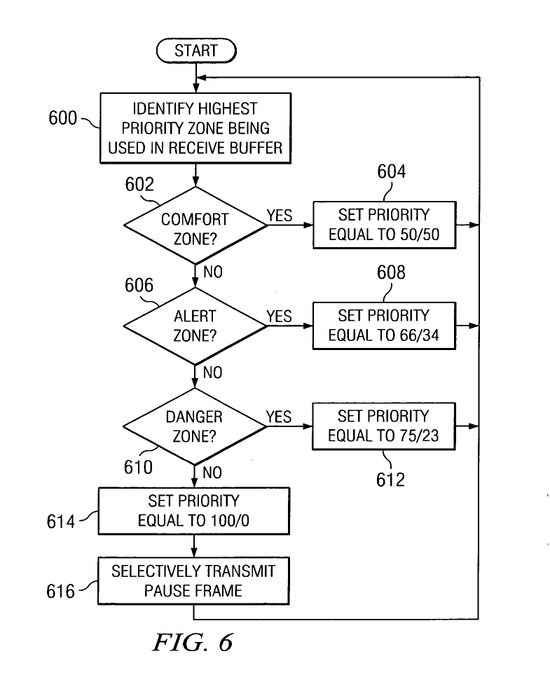

With reference now to FIG. 6, a flowchart of a process for managing transmit and receive functions is depicted in accordance with a preferred embodiment of the present invention. The process illustrated in FIG. 6 may be implemented as instructions or circuitry within an adapter, such as control unit 314 within adapter 300 in FIG. 3.

The process begins by identifying the highest priority zone being used in the receive buffer (step 600). The zones in these examples follow in a descending order of priority as follows: XOFF, danger, alert, and comfort. In this illustrative example, these priorities correspond to the priorities used with buffer usage as illustrated in receive buffer 400 in FIG. 4.

A determination is made as to whether the identified zone is the comfort zone (step 602). If this zone is the identified zone, then the priority is set with the receive and transmit functions having equal priority (step 604) with the process then returning to step 600.

With reference again to step 602, if the zone is not the comfort zone, a determination is made as to whether the zone is an alert zone (step 606). If the use of data within the receive buffer reaches the alert zone, then the priority for the receive function is set equal to 66 percent while the priority for the transmit function is set to 34 percent (step 608) with the process then returning to step 600 as described above. If the identified zone is not the alert zone in step 606, a determination is made as to whether the identified zone is the danger zone (step 610). If the identified zone is the danger zone, then the priority is set with the receive function receiving 75 percent and the transmit priority being equal to 25 percent with the process then returning to step 600.

With reference again to step 610, if the highest zone being used in the receive buffer is not the danger zone, then, the XOFF zone has been reached. The priority for the receive function is set equal to 100 percent with the priority for the transmit function being set to zero percent (step 614). The transmit function is basically turned off or placed in an idle mode to avoid increasing the amount of traffic that may be handled by the receive side. By turning off or idling the transmit function, data requests and acknowledge frames that may be transmitted by the adapter are halted. This state avoids aggravating the overrun situation in the receive buffer.

Further, a pause frame is selectively transmitted (step 616) with the process then returning to step 600 as described above. In step 616, a pause frame is sent onto the network if a prior pause frame has not been sent. Additionally, a pause frame is sent onto the network if the period of time for the prior pause frame is about to expire.

Thus, the present invention provides an improved method, apparatus, and computer instructions for managing the transfer of data in a data buffer. In particular, the mechanism of the present invention manages receive and transmit functions in a manner to avoid an overrun or XOFF mode. The priority of the receive function is increased as the amount of data in a receive buffer increases. Further, if an overrun or XOFF mode is reached, the transmit function is turned off with the receive function receiving all of the priority with respect to resources in the data processing system. In this manner, the amount of time in which the adapter or port is in an overrun or XOFF mode is reduced.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for managing data transfer in a data processing system, the method comprising:
detecting an amount of space available for storing data in a receive buffer; and
responsive to the amount of space available, setting a first priority for a receive function and a second priority for a transfer function, wherein the first priority and the second priority is used to access resources for the data transfer.

2. The method of claim 1, wherein the receive buffer includes a comfort zone, an alert zone, a danger zone, and an overflow zone.

3. The method of claim 2, wherein the detecting step comprises:
detecting zones in the receive buffer in which data is present.

4. The method of claim 3, wherein the selecting step comprises:
setting the first priority and the second priority based on zones in which the data is present.

5. The method of claim 2 further comprising:
transmitting a pause frame onto a network if data is present in the overflow zone.

6. The method of claim 1, wherein the network is an Ethernet network.

7. An apparatus managing transfer of data in a network data processing system, the apparatus comprising:
a network interface;
a receiver buffer; and
a control unit, wherein the control unit detects an amount of space available for storing data in a receive buffer; and sets a first priority for a receive function and a second priority for a transfer function in response to the amount of space available, wherein the first priority and the second priority is used to access resources for the data transfer.

8. The apparatus of claim 7, wherein the apparatus is a switch.

9. The apparatus of claim 7, wherein the apparatus is a network adapter for use in a data processing system.

10. A data processing system for managing data transfer in a data processing system, the data processing system comprising:
detecting means for detecting an amount of space available for storing data in a receive buffer; and
setting means for setting a first priority for a receive function and a second priority for a transfer function, wherein the first priority and the second priority is used to access resources for the data transfer in response to the amount of space available.

11. The data processing system of claim 10, wherein the receive buffer includes a comfort zone, an alert zone, a danger zone, and an overflow zone.

12. The data processing system of claim 11, wherein the detecting means comprises:
means for detecting zones in the receive buffer in which data is present.

13. The data processing system of claim 12, wherein the selecting means comprises:
setting means for setting the first priority and the second priority based on zones in which the data is present.

14. The data processing system of claim 11 further comprising:
transmitting means for transmitting a pause frame onto a network if data is present in the overflow zone.

15. The data processing system of claim 10, wherein the network is an Ethernet network.

16. A computer program product in a computer readable medium for managing data transfer in a data processing system, the computer program product comprising:
first instructions for detecting an amount of space available for storing data in a receive buffer; and
second instructions for setting a first priority for a receive function and a second priority for a transfer function, wherein the first priority and the second priority is used to access resources for the data transfer in response to the amount of space available.

17. The computer program product of claim 16, wherein the receive buffer includes a comfort zone, an alert zone, a danger zone, and an overflow zone.

18. The computer program product of claim 17, wherein the first instructions comprises:
first sub-instructions for detecting zones in the receive buffer in which data is present.

19. The computer program product of claim 18, wherein the second instructions comprises:
second sub-instructions for setting the first priority and the second priority based on zones in which the data is present.

20. The computer program product of claim 17 further comprising:
third instructions for transmitting a pause frame onto a network if data is present in the overflow zone.

21. The computer program product of claim 16, wherein the network is an Ethernet network.
